(19) United States
(12) Patent Application Publication
(10) Pub. No.: US 2025/0368411 A1
(43) Pub. Date: Dec. 4, 2025

(54) ENVIRONMENTALLY FRIENDLY PERSONAL HYGIENE AND BEAUTY PRODUCT PACKAGING

(71) Applicant: Human Essentials Ltd., West Vancouver (CA)

(72) Inventor: Damian Hugo Van Zyll De Jong, West Vancouver (CA)

(21) Appl. No.: 19/008,420

(22) Filed: Jan. 2, 2025

Related U.S. Application Data
(63) Continuation of application No. 17/776,570, filed on May 12, 2022, now abandoned.
(60) Provisional application No. 62/936,211, filed on Nov. 15, 2019.

(51) Int. Cl. B65D 65/46; B65D 3/04; B65D 3/26; B65D 75/58

(52) U.S. Cl. CPC B65D 65/466; B65D 3/04; B65D 3/262; B65D 75/5888; B65D 2565/382; B65D 2575/58

(57) ABSTRACT

Disclosed herein are earth-friendly packaging systems and methods for containing and dispensing consumable products, such as cosmetics or personal hygiene products. In some embodiments, a body of the packaging system comprises a plurality of circumferentially-oriented detachable strips surrounding a consumable product, wherein individual detachable strips can be removed as the consumable product is used.

### CROSS-REFERENCE

This application is a continuation of U.S. application Ser. No. 17/776,570, filed May 12, 2022, which is a U.S. National Phase Application under 35 U.S.C. § 371 of International Application No. PCT/IB2020/000937, filed Nov. 13, 2020, which claims the benefit of U.S. Provisional Application No. 62/936,211, filed Nov. 15, 2019, the entire disclosures of which are incorporated herein by reference.

### BACKGROUND

There is an increasing awareness of plastic pollution and the over use of single-use plastics. Personal hygiene and beauty products commonly come in single-use plastic packaging.

### SUMMARY

This application relates to environmentally friendly packaging and dispensers for personal hygiene and beauty products. In some embodiments, the present disclosure provides an environmentally friendly deodorant dispenser. In some embodiments, the present disclosure provides an environmentally friendly lip product dispenser. In some embodiments, the present disclosure provides an environmentally friendly face product dispenser.

In various embodiments, a packaging system comprises: a body comprising a plurality of detachable strips, wherein a detachable strip of the plurality of detachable strips is separated from an adjacent detachable strip of the plurality of detachable strips by a tear line and wherein the body comprises a first biodegradable material; and a base coupled to a proximal end of the body. In some embodiments, the proximal end of the body is disposed at least partially within a cavity of the base. In some embodiments, the base comprises a second biodegradable material. I some embodiments, the packaging system further comprises a cap. In some embodiments, the cap comprises a second biodegradable material. In some embodiments, a proximal end of the cap abuts a distal end of the base. In some embodiments, a distal end of the body is disposed at least partially within the cap. In some embodiments, the first end of the body comprises a knurled edge. In some embodiments, the packaging system further comprises a plug. In some embodiments, at least a portion of the plug is disposed within a cavity of the base. In some embodiments, the packaging system further comprises a consumable product disposed substantially inside of the body. In some embodiments, the consumable product is disposed at least partially within the cavity of the base. In some embodiments, the consumable product is in contact with a distal end of the plug. In some embodiments, the plug comprises one or more prongs, wherein at least one of the one or more prongs extends inside of the consumable product. In some embodiments, the consumable product is a cosmetic. In some embodiments, the consumable product is a personal hygiene product. In some embodiments, the base is rigid. In some embodiments, the cap is rigid. In some embodiments, a detachable strip of the plurality of detachable strips comprises a tab at a first circumferential end of the detachable strip. In some embodiments, the tab overlaps a second circumferential end of the detachable strip. In some embodiments, each detachable strip of the plurality of detachable strips is separated from an adjacent detachable strip of the plurality of detachable strips by a tear line. In some embodiments, the biodegradable material comprises paper. In some embodiments, the first biodegradable material comprises tube board. In some embodiments, the biodegradable material comprises paperboard. In some embodiments, the biodegradable material comprises solid bleached sulfate (SBS). In some embodiments, the biodegradable material consists essentially of paper. In some embodiments, the height of the body is from 25 mm to 200 mm. In some embodiments, the outer diameter of the body is from 25 mm to 75 mm.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings of which:

FIG. 1A illustrates a packing system comprising a body and a base, in accordance with one or more embodiments herein.

FIG. 1B illustrates a packaging system comprising a base and a cap, in accordance with one or more embodiments herein.

FIG. 1C illustrates a top view of a packaging system, in accordance with one or more embodiments herein.

FIG. 2A illustrates a packaging system comprising a body and a base, in accordance with one or more embodiments herein.

FIG. 2B illustrates a cross-section view of a packaging system shown in FIG. 2A, in accordance with one or more embodiments herein.

FIG. 2C illustrates a cross-section view of a packaging system shown in FIG. 2A, in accordance with one or more embodiments herein.

FIG. 3A shows an assembled cap and base of a packaging system, in accordance with one or more embodiments herein.

FIG. 3B shows a packaging system comprising a body and a base, in accordance with one or more embodiments herein.

FIG. 3C shows a packaging system comprising a body, in accordance with one or more embodiments herein.

FIG. 4 shows a packaging system comprising a body, a base, and a cap, in accordance with one or more embodiments herein.

FIG. 5 illustrates a packaging system comprising a plurality of detachable strips, in accordance with one or more embodiments herein.

FIG. 6 illustrates a packaging system comprising a body, a base, and a cap, in accordance with embodiments.

FIG. 7A illustrates a sheet comprising a plurality of detachable strips, in accordance with one or more embodiments herein.

FIG. 7B illustrates a packaging system comprising a plurality of detachable strips, in accordance with one or more embodiments herein.

FIG. 7C illustrates a sheet comprising a plurality of detachable strips, in accordance with one or more embodiments herein.

FIG. 8A illustrates a sheet comprising a plurality of detachable strips, in accordance with one or more embodiments herein.

FIG. 8B illustrates a packaging system comprising a plurality of detachable strips, in accordance with one or more embodiments herein.

FIG. 9A illustrates a sheet comprising a plurality of detachable strips, in accordance with one or more embodiments herein.

FIG. 9B illustrates a packaging system comprising a plurality of detachable strips, in accordance with one or more embodiments herein.

FIGS. 10A-10D illustrate top views of packaging system plugs, in accordance with one or more embodiments herein.

FIGS. 10E-10F illustrate cross-sectional views of packaging system plugs, in accordance with one or more embodiments herein.

FIGS. 11A-11D illustrate cross-sectional views of packaging system plugs, in accordance with one or more embodiments herein.

FIGS. 11E-11F illustrate cross-sectional views of packaging system plugs, in accordance with one or more embodiments herein.

FIGS. 12A-12E illustrate packaging system plugs, in accordance with one or more embodiments herein.

FIG. 13A illustrates an exterior view of a cap, in accordance with one or more embodiments herein.

FIG. 13B illustrates a cross-section view of a cap, in accordance with one or more embodiments herein.

FIG. 13C illustrates an end view of a distal end of a cap, in accordance with one or more embodiments herein.

### DETAILED DESCRIPTION

Disclosed herein are environmentally-friendly packaging systems 1000 and methods for containing and dispensing consumable products 400, such as beauty and personal hygiene products. Current packaging systems for such consumable products 400 are often made of single-use plastic that takes an exceedingly long time to decompose. The packaging systems and methods disclosed herein comprise environmentally friendly (e.g., biodegradable) materials, allowing convenient and environmentally-responsible disposal of single-use consumer goods, such as cosmetics and personal hygiene products.

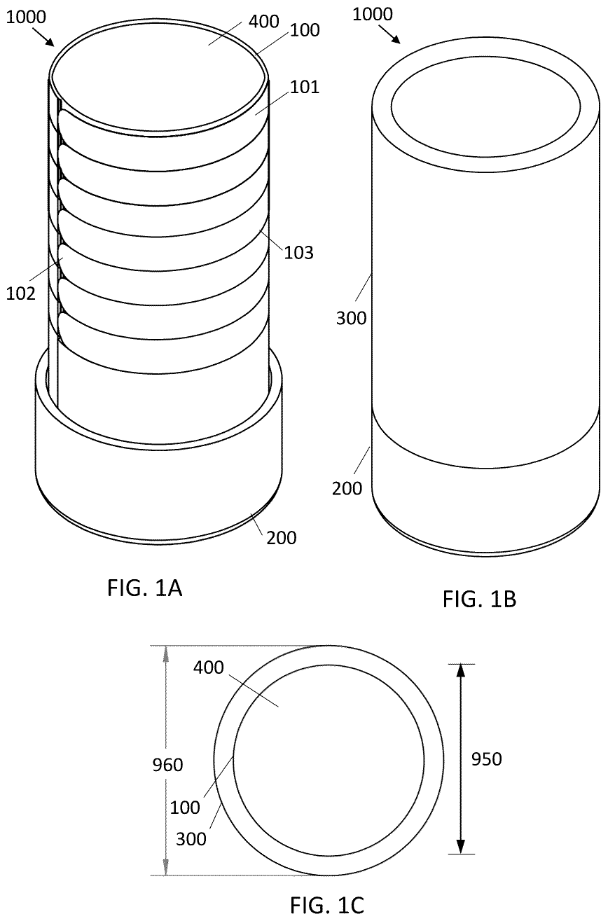

FIG. 1A shows a biodegradable packaging system 1000 comprising a body 100 and a base 200. As depicted in FIG. 1A, a consumable product (e.g., a cosmetic or personal hygiene product) can be contained within the body 100 and/or the base 200 of the biodegradable packaging system 1000. A body 100 of a biodegradable packaging system 1000 can comprise one or more detachable strips 101. In many cases, a body 100 of a biodegradable packaging system 1000 comprises a plurality of detachable strips 101. For example, a body 100 can comprise 1, 2, 3, 4, 5, 6, 7, 8, 9, 10 11, 12, 13, 14, 15, 16, 17, 18, 19, 20, 20 to 50, 50 to 100, or more than 100 detachable strips 101. A body 100 and/or one or more detachable strips 101 of a biodegradable packaging system 1000 can comprise a biodegradable material. In many cases, all detachable strips 101 of a biodegradable packaging system 1000 can comprise a biodegradable material. A body 100 comprising detachable strips 101 can be advantageous over existing technologies because individual detachable strips 101 may be processed (e.g., via biodegradation or recycling) more quickly than an intact packaging system body 100 (e.g., wherein bulkier intact packaging may take longer to biodegrade than shredded packaging and/or wherein mechanisms to advance a product within the packaging is more difficult to recycle or degrade). A body 100 comprising one or more detachable strips 101 can also offer an advantage to the ease of manufacture of a packaging system over existing technologies, as detachable strips 101 can offer a means for a consumer to access the product that can be manufactured cheaply and simply. In some cases, a body 100 comprising a plurality of detachable strips 101 can provide a user with the ability to select how much product is exposed at a given time, for example, by allowing the user to pull off multiple detachable strips 101 in together or in succession. A body 100 comprising detachable strips 101 can also offer advantages to design of the body's contour and/or shape. For example, existing technologies that make use of a mechanism for advancing a product longitudinally through the body of the packaging (e.g., using a screw twist mechanism, for example, with a movable platform) cannot comprise a non-uniform longitudinal shape (e.g., an hourglass shape) to dispense a rigid or semi-rigid product because the product cannot be advanced through the waist region of the packaging. In contrast, any contour (e.g., profile) shape (for example, including shapes that have a variable (e.g., non-constant) diameter over the height of the packaging) can be used in biodegradable packaging systems presented herein, for example, because detachable strips 101 can be peeled away to expose product rather than requiring that the product be pushed through the body 100 for use.

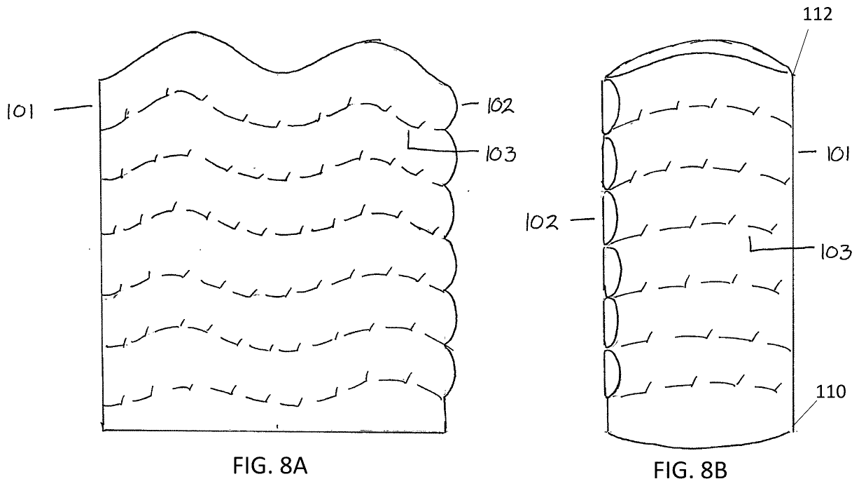

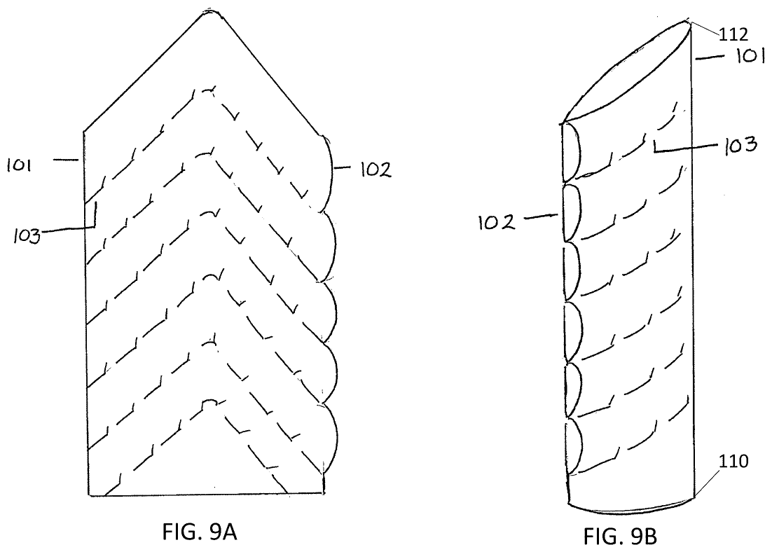

In many cases, one or more detachable strips 101 of a body 100 can be oriented in a circumferential (e.g., as shown in FIGS. 1-2B, 3B, 4, 5, 7A, and 7B) or a substantially circumferential direction (e.g., as shown in FIGS. 8A, 8B, 9A, and 9B). In some cases, a circumferential direction is in a plane perpendicular to a longitudinal axis 700 of the biodegradable packaging system 1000. A detachable strip 101 of a body 100 can comprise a biodegradable material (e.g., a biodegradable packaging material).

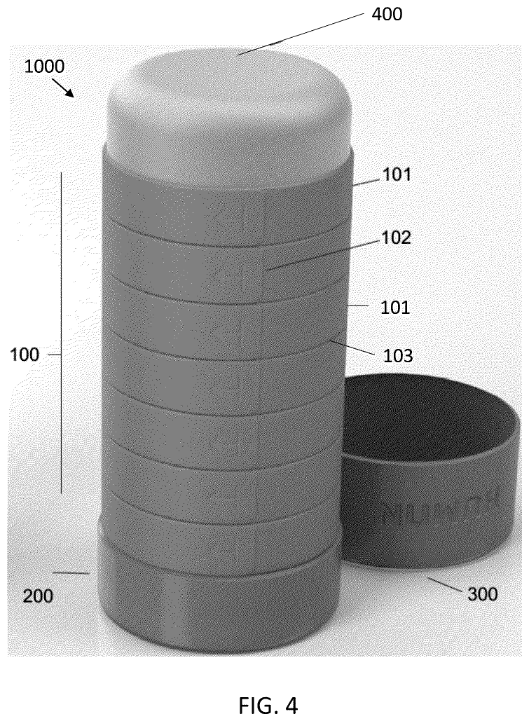

In many cases, a detachable strip 101 comprise a tab 102. A tab can be a portion of a detachable strip 101 at a first (e.g., circumferential) end of the detachable strip 101, which can overlap a second (e.g., circumferential) end of the detachable strip 101. A tab 102 can be used to remove a detachable strip 101 from the biodegradable packaging system 1000. For example, a user may grasp the tab 102 (e.g., between the thumb and forefinger) and pull at radially and in a clockwise and/or counterclockwise direction around a longitudinal axis of the system 1000 (e.g., depending on which direction the detachable strip 101 and its first and second ends are oriented around the longitudinal axis of the system). A tab 102 can comprise contouring (e.g., in-plane contouring), for example, to aid in grasping the tab 102 (e.g., sliding a finger under the tab 102). In some cases, contouring of a first end of one or more detachable strips 101 of body 100 can be achieved via die-cutting or laser-cutting a sheet of biodegradable material. In some cases, a tab 102 comprises marking (e.g., embossing, debossing (e.g., as shown in FIG. 4), or pigment marking), for instance, to indicate how to detach the detachable strip 101 from body 100.

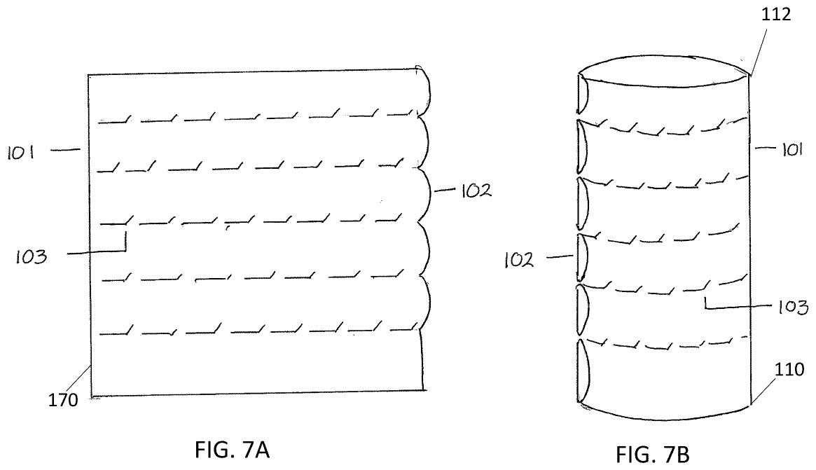

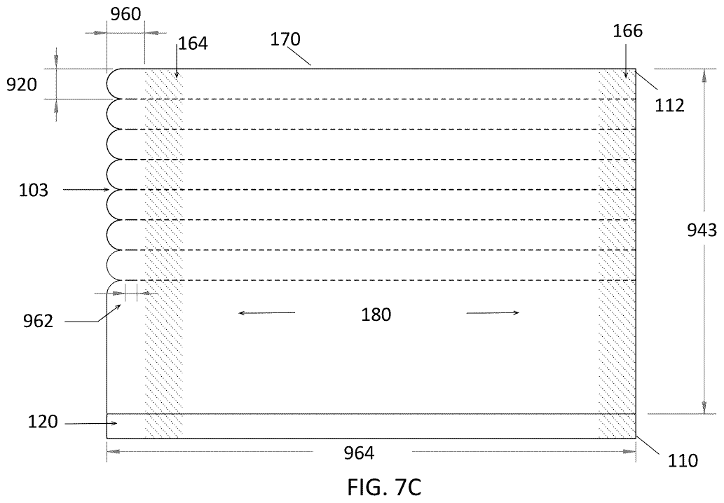

As shown in FIG. 7C, tab 102 can comprise a length of a detachable strip 101 from the first end of the detachable strip to a portion of the first end of the detachable strip that can be coupled to the second end of the detachable strip (e.g., with an adhesive), for example, when a sheet comprising the detachable strip 101 is formed into a three-dimensional shape. In some cases, the length 960 of a tab 102 can be 1 mm to 20 mm, 5 mm to 15 mm, 5 mm to 10 mm (e.g., as measured from the tip of a first end of detachable strip 101 to a location 164 at which a second end of the detachable strip 101 is coupled to the first end of the detachable strip). In some cases, tab 102 can comprise a non-contoured length 962 of 0.1 mm to 10 mm, 0.5 mm to 5 mm, or 1 mm to 3 mm. In some cases, length 962 can comprise the same perforation and/or scoring pattern as a second portion of a tear line 103 of a detachable strip 101. In some cases, length 962 can comprise a different perforation and/or scoring pattern as a second portion of tear line 103. In some cases, length 962 can comprise a perforation pattern comprising a sequence of 1 mm, 3 mm, and 1 mm long perforations.

A detachable strip 101 of a biodegradable packaging system 1000 can be coupled to an adjacent detachable strip 101 of the biodegradable packaging system 1000 by a tear line 103. In some cases, each detachable strip 101 is coupled to an adjacent detachable strip 101 by a tear line 103. In some cases, all but two detachable strips 101 (e.g., excepting a detachable strip 101 at a first end of the body 100 and a detachable strip 101 at a second end of the body 100) of a biodegradable packaging system 1000 are coupled to two adjacent detachable strips 101. A tear line 103 can facilitate detachment of a detachable strip 101 (e.g., from a body 100 and/or from an adjacent detachable strip 101 of the body 100), for example, when a user pulls on a tab 102 of the detachable strip 101. In some cases, a tear line 103 comprises a perforation (e.g., a microperforation) of the material of the body 100 (e.g., wherein portions of the material of the body 100 has been cut through the entire thickness of the material of the body 100). In some cases, a tear line 103 comprises a portion of the body 100 that has been scored (e.g., cut partially but not completely through the thickness of the material of the body 100). In some cases, the tear line 103 comprises scoring (e.g., kiss-cut tear lines) around the entire circumference of the body 100. In some cases, the tear line 103 comprises scoring along the entire length (e.g., from a first circumferential end to a second circumferential end) of the detachable strip 101 or body 100. In some cases, the tear line 103 comprises perforation and scoring.

In some cases, a body 100 and/or detachable strip 101 comprises a biodegradable material (e.g., art paper, recycled paper, certified sustainable recycled paper, etc.) For example, a body 100 can comprise a biodegradable material having a grammage of from 50 gram per square meter (gsm) to 400 gsm, from 100 gsm to 250 gsm, from 125 gsm to 200 gsm, from 130 gsm to 190 gsm, from 140 gsm to 180 gsm, from 150 to 170 gsm, from 150 gsm to 160 gsm, from 155 to 160 gsm, less than 50 gsm, or greater than 400 gsm. In some cases, body 100 and/or detachable strip 101 comprises a coating (e.g., a varnish, such as soft touch varnish). In some cases, body 100 and/or detachable strip 101 comprises tube board (e.g., having a thickness of 0.5 to 1.5 mm, 0.75 to 1.25 mm, or 1.00 to 1.25 mm). In some cases, body 100 and/or detachable strip 101 comprises a laminate (e.g., a matte laminate disposed as an outer layer of the body and/or detachable strip 101). In some cases, the laminate can be 0.010 mm to 0.015 mm, 0.015 to 0.5 mm, or 0.5 to 0.75 mm thick. In some cases, a body 100 can have an outer diameter 950 (e.g., maximum dimension perpendicular to a longitudinal axis 700) of from 10 mm to 100 mm, from 25 mm to 75 mm, from 40 mm to 60 mm, or from 45 mm to 50 mm. In some cases, a body 100 can have a height (e.g., in a longitudinal direction parallel to a longitudinal axis 700) of from 20 mm to 300 mm, from 25 mm to 200 mm, from 50 mm to 150 mm, from 75 mm to 100 mm, from 60 mm to 80 mm, or from 70 mm to 90 mm, less than 20 mm, or greater than 300 mm. In some cases, a body 100 can have an inner dimension (e.g., inner diameter) of from 10 mm to 100 mm, from 25 mm to 75 mm, from 40 mm to 60 mm, or from 45 mm to 50 mm. In some cases, a body 100 can have a height (e.g., in a longitudinal direction) of from 25 mm to 200 mm, from 50 mm to 150 mm, from 75 mm to 100 mm, from 60 mm to 80 mm, or from 70 mm to 90 mm. In some cases, a detachable strip 101 can have a width 920 from 1 mm to 5 mm, 5 mm to 8 mm, 8 mm to 10 mm, 10 mm to 15 mm, 15 mm to 25 mm, 25 mm to 50 mm, or greater than 50 mm. In some cases, a detachable strip 101 can have a thickness (e.g., measured before or after forming a sheet comprising the detachable strip 101 into a three-dimensional shape) from 0.1 mm to 5 mm, 1 mm to 4 mm, 2 mm to 3 mm, or more than 5 mm.

A biodegradable packaging system 1000 can comprise a base 200. In many cases, a base 200 can serve as a handle or grip for a user (e.g., against which force can be applied when using the product and/or when detaching a detachable strip 101). A base 200 of a biodegradable packaging system 1000 can comprise a biodegradable packaging material. In some cases, a base 200 can comprise an inner dimension (e.g., inner diameter) equal to or larger than an outer dimension (e.g., outer diameter) 950 of the body 100 of a biodegradable packaging system 1000. In many cases, an outer dimension (e.g., outer diameter) of a base 200 can be slightly larger than the outer dimension (e.g., outer diameter) 950 of body 100. A proximal end 110 of a body 100 can be disposed within all or a portion of the base 200 (e.g., radially closer to a longitudinal axis 700 than all or a portion of the base 200). In some cases, a body 100 (e.g., an outer surface or portion thereof) or portion of body 100 (e.g., proximal end 110) can be coupled to an inner surface or portion thereof of base 200 (e.g., using an adhesive, such as a biodegradable material like starch), for instance to prevent rotation or axial movement of body 100 relative to base 200.

In some cases, a base 200 comprises a wall thickness greater than that of a body 100 or portion thereof (e.g., to provide the base 200 with greater rigidity than the detachable strips 101, which may benefit from a greater degree of deformability, e.g., during detachment)). In some cases, a base 200 comprises a biodegradable material, such as recycled paper, certified recycled paper, or art paper (e.g., having a grammage of from 50 gsm to 400 gsm, from 100 gsm to 250 gsm, from 125 gsm to 200 gsm, from 130 gsm to 190 gsm, from 140 gsm to 180 gsm, from 150 to 170 gsm, from 150 gsm to 160 gsm, from 155 to 160 gsm, less than 50 gsm, or greater than 400 gsm). In some cases, a base 200 comprises a coating (e.g., a wax such as soybean-based wax, a varnish, such as soft touch varnish). In some cases, a base 200 comprises tube board (e.g., having a thickness of 0.5 to 1.5 mm, 0.75 to 1.25 mm, or 1.00 to 1.25 mm). In some cases, base 200 is rigid or semi-rigid (e.g., under compression in a longitudinal direction and/or under bending forces).

A biodegradable packaging system 1000 can comprise a cap 300, e.g., as shown in FIG. 1B. In many cases, cap 300 is positioned over and/or around all or a portion of body 100 (e.g., to protect one or more detachable strips 101 from unintentionally being partially or fully detached, for example, during handling or storage in a purse or pocket) and, in many cases, can be slid on or off during use or storage. In many cases, cap 300 is designed to slide over all or a portion of body 100 (e.g., such that body 100 is disposed at least partially within cap 300). In many cases, a proximal end of cap 300 abuts a distal end of base 200. In many cases, cap 300 comprises a biodegradable material (e.g., a biodegradable packaging material). In some cases, cap 300 has an inner dimension (e.g., inner diameter) equal to or larger than a maximum outer dimension (e.g., maximum diameter) 950 of body 100 or a portion thereof. For example, FIG. 1C illustrates some embodiments in which cap 300 has an inner dimension (e.g., inner diameter) approximately equal to a maximum outer dimension 950 of body 100 and wherein cap 300 has a maximum outer dimension 960 (e.g., maximum diameter) larger than the maximum outer dimension (e.g., outer diameter) of body 100. In some cases, cap 300 has an inner dimension (e.g., diameter) equal to or approximately equal to the inner dimension (e.g., inner diameter) of a base 200. In some cases, cap 300 has a maximum outer dimension (e.g., outer diameter) 960 equal to or approximately equal to the maximum outer dimension (e.g., outer diameter) of base 200. In some cases, the maximum outer dimension (e.g., outer diameter) 960 of cap 300 is from 10 mm to 125 mm, from 25 mm to 75 mm, from 40 mm to 60 mm, or from 45 mm to 55 mm. Cap 300 may have a thickness greater than the thickness of body 100 or a portion thereof, for example, to provide greater rigidity and/or strength than body 100 and/or detachable strip 101 (e.g., to prevent deformation of a product 400 disposed within body 100, for example, during handling, use, or storage). In some cases, cap 300 is rigid or semi-rigid (e.g., under compression in a longitudinal direction and/or under bending forces). Cap 300 can have a height 941 of 20 mm to 300 mm, 50 mm to 200 mm, 75 mm to 150 mm, 80 mm to 100 mm, greater than 300 mm, or less than 20 mm. In some cases, cap 300 has a height 941 that is from 70% to 99%, from 80% to 95%, from 85% to 90%, less than 70%, or greater than 99% of the height of body 100. A cap 300 can comprise a biodegradable material having a grammage of from 50 gsm to 400 gsm, from 100 gsm to 250 gsm, from 125 gsm to 200 gsm, from 130 gsm to 190 gsm, from 140 gsm to 180 gsm, from 150 to 170 gsm, from 150 gsm to 160 gsm, from 155 to 160 gsm, less than 50 gsm, or greater than 400 gsm.

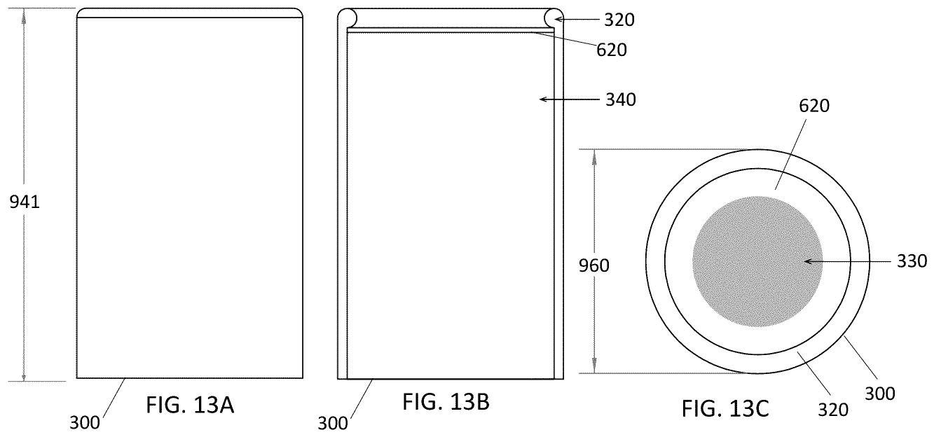

In some cases, a distal end of cap 300 is closed. For example, the material cap 300 can comprise no apertures, breaks, or other openings, in some cases. In some cases, a cap 300 that comprises no apertures can retain moisture within biodegradable packaging system 1000, e.g., to reduce the rate at which a product 400 might dry out before or between uses. A surface of a cap 300 can comprise an embossed or debossed logo 330 or design. In some cases, an end plate (e.g., a proximal end plate 600 or a distal end plate 620, which may be coupled to or retained by contact with a distal end of cap 300) can comprise an embossed or debossed logo 330 or design, for example, as shown in FIG. 13C. In some cases, a distal end of cap 300 comprises an aperture. In many cases, a proximal end of cap 300 comprises an aperture.

In some cases, a surface of a distal end of cap 300 (e.g., a surface perpendicular to longitudinal axis 700 or angled relative to longitudinal axis 700) is flat. In some cases, a surface of a distal end of cap 300 is not flat. For instance, a surface of a distal end of cap 300 can be curved. In some cases, a surface of a distal end of cap 300 can comprise a convex curve. In some cases, a surface of a distal end of cap 300 can comprise a concave curve.

As shown in FIG. 13A, cap 300 can comprise one or more beveled edges (e.g., at a distal end of cap 300). In some cases, a distal end of cap 300 comprises a rolled edge 320, for example, as shown in FIG. 13B. A rolled edge 320 can define a bevel to an edge of cap 300, in some cases. Rolled edges can be formed before a material for cap 300 is formed into a three-dimensional shape (e.g., while the material for cap 300 is a two-dimensional sheet. In some cases, a rolled edge can be formed after a material for cap 300 is formed into a three-dimensional shape. The side wall(s) of cap 300 can be straight. In some cases, the side wall(s) of cap 300 are not straight. For example, one or more side walls of cap 300 can comprise a curved surface in a plane perpendicular to a longitudinal axis 700 of cap 300. In some cases, one or more side walls of cap 300 can comprise a curved surface in a plane that is not perpendicular to longitudinal axis 700 of cap 300, for example, a sagittal plane.

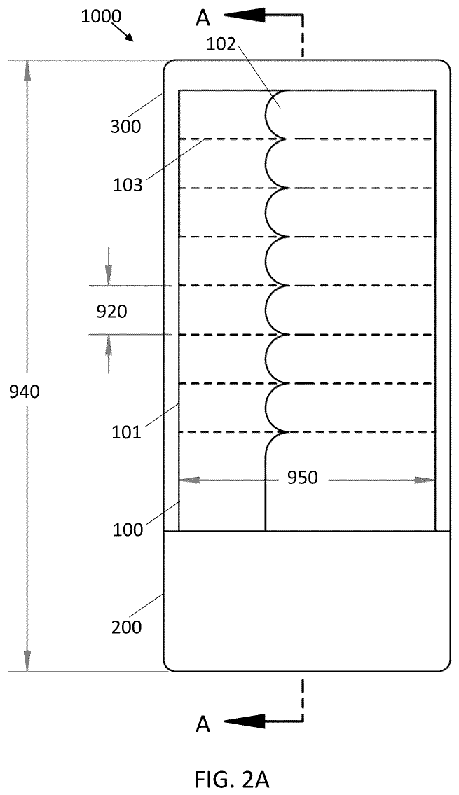

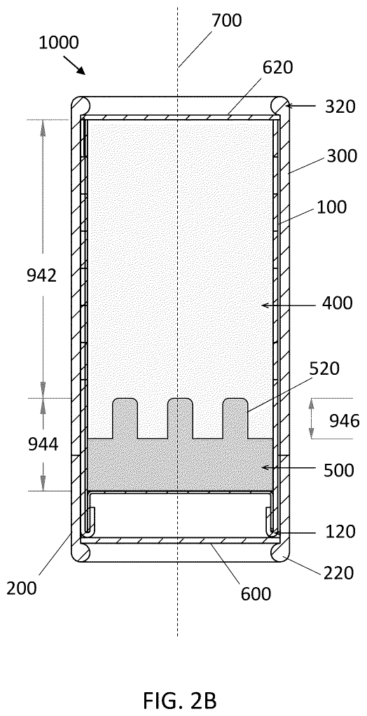

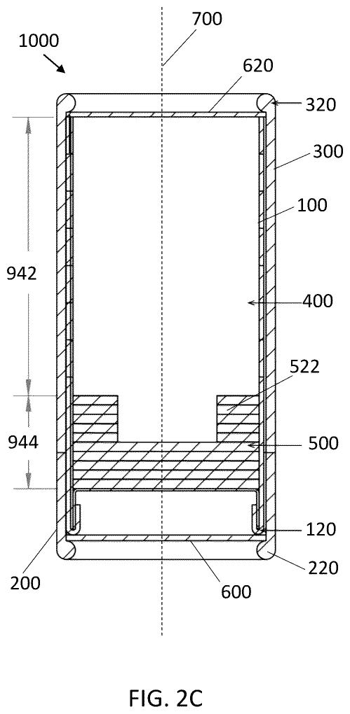

FIG. 2A shows a cutaway view of a biodegradable packaging system 1000 comprising a body 100, a base 200, and a cap 300. FIG. 2A shows an embodiment wherein detachable strips 101 are separated from an adjacent detachable strip 101 by a perforated tear line 103. In some cases, a biodegradable packaging system 1000 can have an overall height 940 of 20 mm to 300 mm, 50 mm to 200 mm, 75 mm to 150 mm, 80 mm to 100 mm, greater than 300 mm, or less than 20 mm.

In some cases, a biodegradable packaging system 1000 comprises a proximal end plate 600 and/or a distal end plate 620 (e.g., as shown in FIG. 2B). In some cases, an end plate (e.g., a proximal end plate 600 and/or a distal end plate 620) can simplify the manufacture of individual components of a biodegradable packaging system 1000. For example, an end plate 600 or 620 can be disposed at an end of body 100 (e.g., proximal end 110 and distal end 112, respectively) to form an end wall of biodegradable packaging system 1000, which can eliminate the need for base 200 and/or cap 300 to have a both a side wall and an end wall (e.g., as shown in FIG. 2B and FIG. 2C). In some cases, a base 200 and/or a cap 300 can comprise a lip (for example, lips 220 and 320, as shown in FIG. 2B and FIG. 2C), for example to retain an end plate in its position at a proximal or distal end of body 100 (e.g., by biasing an end plate against either a proximal or distal end of body 100). In some cases, lip 220 and/or 320 comprises a rolled edge of a side wall of cap 300.

A biodegradable packaging system 1000 can comprise a plug 500 (e.g., as shown in FIG. 2B). In some cases, a plug 500 can help to maintain the position of a consumable product 400 (e.g., within the body 100 of a biodegradable packaging system 1000). For example, a plug 500 can comprise one or more prongs 520 extending into a consumable product 400 (e.g., as shown in FIG. 2B), which can, for instance, to reduce displacement of the consumable product during use. In some cases, a body 100 of a biodegradable packaging system 1000 can comprise a knurled edge 120, e.g., at a proximal end 110. In some cases, a knurled edge can be useful in maintaining a position of a plug 500 in a body 100 of a biodegradable packaging system 1000. In some cases, a knurled edge can contact an end plate (e.g., proximal end plate 600) and/or a lip (e.g., base lip 220), for example, to maintain a position of plug 500 and/or body 100 relative to base 200. In some cases, a knurled edge of body 100 (e.g., at a proximal end of body 100) can comprise a height of from 1% to 30%, from 5% to 20%, from 10% to 15%, greater than 30%, or less than 1% of the height of body 100. In some cases, a portion of body 100 that does not comprise a knurled edge can be a height 943 from 70% to 99%, from 80% to 95%, from 85% to 90%, greater than 99%, or less than 70% of the height of body 100.

A plug 500 can have a height 944 (e.g., in a longitudinal direction) of from 1 mm to 5 mm, from 5 mm to 10 mm, from 15 mm, from 15 mm to 20 mm, from 20 mm to 30 mm, or greater than 30 mm. In some cases, a prong of a plug 500 can have a height 944 of 1 mm to 5 mm, 5 mm to 10 mm, 10 mm to 15 mm, from 15 mm to 20 mm, or more than 20 mm (e.g., in a longitudinal direction). In some cases, a consumable product 400 can extend a height 942 above a plug 500. In some cases, a consumable product 400 extends a height 942 of from 5 mm to 150 mm, from 20 mm to 125 mm, from 50 mm to 125 mm, from 60 mm to 125 mm, from 75 mm to 125 mm, greater than 150 mm, or less than 5 mm in a distal direction from the distal end of plug 500. A plug 500 can have a maximum outer dimension 945 smaller than the inner dimension (e.g., inner diameter) of body 100 and/or base 200. For example, plug 500 can have a maximum outer dimension 945 slightly smaller than an inner dimension (e.g., inner diameter) of body 100 and/or base 200. In some cases, plug 500 can comprise a maximum outer dimension 945 of from 10 mm to 100 mm, from 25 mm to 75 mm, from 40 mm to 60 mm, or from 45 mm to 50 mm.

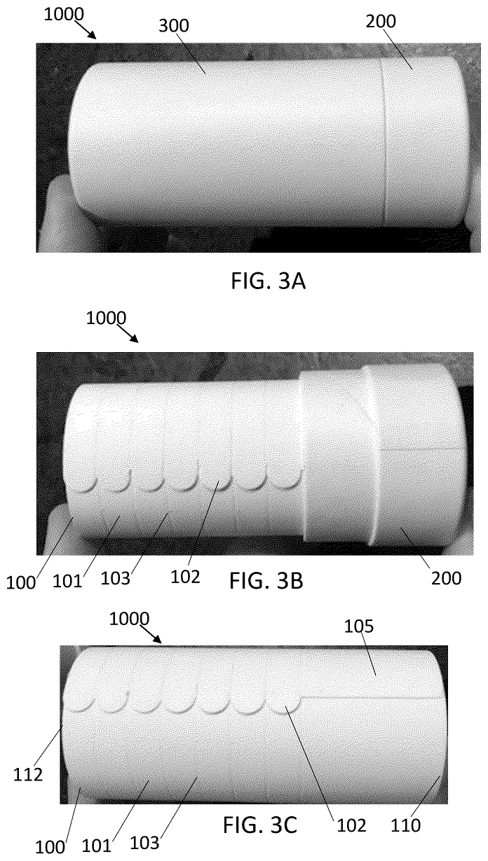

FIG. 3A shows an example of a biodegradable packaging system 1000 comprising a cap 300 and a base 200, wherein the maximum outer dimension (e.g., outer diameter) of the cap 300 is equal to the maximum outer dimension (e.g., outer diameter) of the base 200. In some cases, the maximum outer dimension and/or an inner dimension (e.g., outer diameter and/or inner diameter) of the cap 300 is constant from a proximal end of the cap 300 to a distal end of the cap 300. In some cases, the maximum outer dimension and/or an inner dimension (e.g., outer diameter and/or inner diameter) of the cap 300 is not constant from a proximal end of the cap 300 to a distal end of the cap 300. For example, the maximum outer dimension and/or an inner dimension (e.g., outer diameter and/or inner diameter) of cap 300 increases from a proximal end of cap 300 to a distal end of cap 300. In some cases, the maximum outer dimension and/or an inner dimension (e.g., outer diameter and/or inner diameter) of cap 300 decreases from a proximal end of cap 300 to a distal end of cap 300. In some cases, the maximum outer dimension and/or an inner dimension (e.g., outer diameter and/or inner diameter) of the base 200 is constant from a proximal end of the base 200 to a distal end of the base 200. In some cases, the maximum outer dimension and/or an inner dimension (e.g., outer diameter and/or inner diameter) of base 200 is not constant from a proximal end of base 200 to a distal end of base 200. In some cases, the maximum outer dimension and/or an inner dimension (e.g., outer diameter and/or inner diameter) of base 200 increases from a proximal end of base 200 to a distal end of base 200. In some cases, the maximum outer dimension and/or an inner dimension (e.g., outer diameter and/or inner diameter) of base 200 decreases from a proximal end of base 200 to a distal end of base 200.

FIG. 3B shows an example of a biodegradable packaging system 1000 comprising a body 100 and a base 200 wherein a maximum outer dimension (e.g., outer diameter) of body 100 is less than an inner dimension (e.g., inner diameter) of base 200 and at least a portion of body 100 is disposed within base 200. FIG. 3C shows an example of a biodegradable packaging system 1000 comprising a body 100. In some cases, the maximum outer dimension and/or an inner dimension (e.g., the outer diameter and/or the inner diameter) of body 100 is constant. In some cases, the maximum outer dimension and/or an inner dimension (e.g., the outer diameter and/or the inner diameter) of body 100 is not constant. In some cases, the maximum outer dimension and/or an inner dimension (e.g., the outer diameter and/or the inner diameter) of body 100 increases from a proximal end of body 100 to a distal end of body 100. In some cases, the maximum outer dimension and/or an inner dimension (e.g., the outer diameter and/or inner diameter) of body 100 decreases from a proximal end of body 100 to a distal end of body 100.

FIG. 4 shows a packaging system 1000 comprising a body 100, a base 200, and a cap 300 with a consumable product 400 disposed within the biodegradable packaging system 1000 (e.g., wherein the consumable product 400 is a personal hygiene or a beauty product, such as deodorant, lip balm, lip stick, etc.). The body 100 may encircle or contain the consumable product 400. In some cases, the maximum outer dimension and/or an inner dimension (e.g., the outer diameter and/or inner diameter) of a body 100 can be the same as the maximum outer dimension and/or an inner dimension (e.g., the outer diameter and/or inner diameter) of base 200 and/or the maximum outer dimension and/or an inner dimension (e.g., the outer diameter and/or inner diameter) of cap 300, for example as shown in FIG. 4. In some cases, a distal end of body 100 abuts a proximal end of cap 300. In some cases, a distal end of base 200 abuts a proximal end of body 100. The base 200 may be positioned at a proximal end of the consumable product 400. In some embodiments, the base overlaps a bottom end of the body. For example, a portion of body 100 (e.g., a proximal end of body 100) can be disposed within all or a portion of base 200. In some embodiments, the base is contiguous with the bottom end of the body. In some cases, cap 300 may be positioned distal to consumable product 400. For example, a portion of body 100 (e.g., a distal end of body 100) can be disposed within all or a portion of cap 300. In some embodiments, the cap is removable from the distal end of the consumable product 400 and/or the distal end of body 100. Body 100 may comprise a plurality of detachable strips 101 which may be incrementally removed to reveal more product 400 as the product 400 is used. As shown in FIG. 4, a detachable strip 101 may comprise a tab 102 positioned at a first end of the detachable strip. The first end of the strip comprising the tab may overlap a second end of the strip, thereby encircling the product. The tab may facilitate detachment or removal of the detachable strip. Each detachable strip 101 of the plurality of detachable strips 101 may be connected to another detachable strip 101 of the plurality of detachable strips 101 via a tear line 103. In some embodiments, a tear line 103 may be perforated, scored, or partially cut to facilitate detachment or removal of a first detachable strip 101 from a second detachable strip 101. In some embodiments, a tear line 103 may comprise a plurality of holes. A tear line 103 may comprise a path of less resistance along the body such that the body tears more easily along a tear line 103 than through another region of the body.

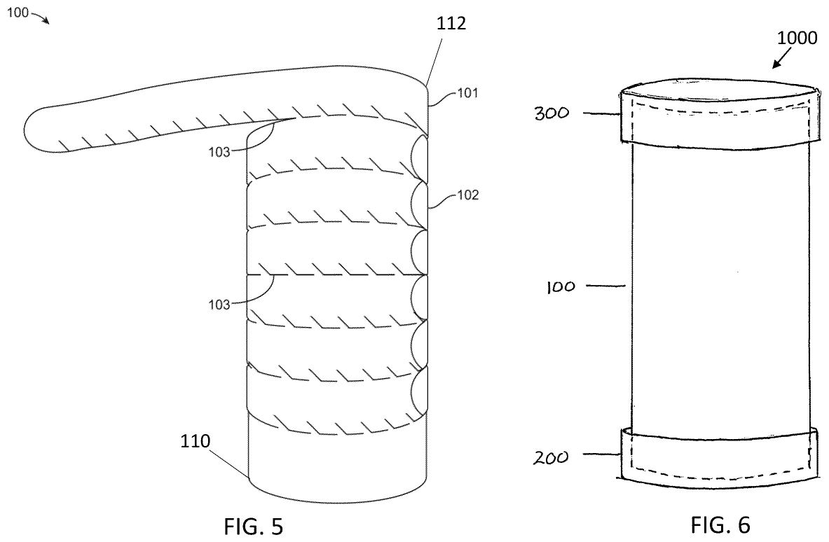

FIG. 5 shows a body 100 comprising a plurality of detachable strips 101. A first detachable strip 101 and a second detachable strip 101 can be coupled by a tear line 103 (e.g., wherein the first and second detachable strips 101 are adjacent to one another). In some cases, a plurality of detachable strips 101 can have an equal width. In some cases, a plurality of detachable strips 101 have different widths. In some cases, all of the detachable strips 101 of body 100 can have equal widths. In some cases, all of the detachable strips 101 of body 100 can have different widths. In some cases, a first detachable strip 101 of body 100 having a larger inner dimension (e.g., inner diameter), for instance when the body 100 is formed into a three-dimensional shape, than a second detachable strip 101 of body 100 may also have a larger width than the second detachable strip 101, for example, to expose the same or similar amount of product each time a detachable strip is removed from body 101. In many cases, a detachable strip 101 can be detached (e.g., peeled away) individually. Each strip 101 may comprise a tab 102 positioned at a first end of the strip 101 to facilitate detachment or removal of each strip 101. The strip 101 may be configured to detach along a tear line 103. The tear line 103 may be perforated, scored, or partially cut to facilitate detachment or removal of the strip. A user may pull the tab 102 of detachable strip 101, causing the strip to separate from body 100 along the tear line 103, as shown in FIG. 5. Detachable strips may comprise a biodegradable material, allowing each detachable strip to be individually removed and recycled, composted, or discarded. A user may remove the cap to use the beauty product by contacting an exposed surface of the beauty product to a skin area. Upon repeated use, the amount of exposed beauty product may be reduced to a point where contacting the product is inconvenient or uncomfortable. A user may remove a detachable strip 101 by pulling on a tab 102 to tear along a tear line 103, thereby removing the strip and exposing more of the product. The lid may then be re-positioned to cover the product. This process may be repeated until the product is used up.

FIG. 6 shows a biodegradable packaging system 1000 comprising a body 100, a base 200, and a cap 300. Cap 300 may be dimensioned (e.g., with a larger inner diameter than an outer diameter of body 100, e.g., at a distal end of body 100) and positioned to overlap a distal end of a body 100. A base 200 may be dimensioned (e.g., with a larger inner diameter than an outer diameter of body 100, e.g., at a proximal end of body 100) positioned to overlap a proximal end of the body 100. In some cases, base 200 may be contiguous with the proximal end of body 100. In some cases, cap 300 can partially overlap body 100, thereby protecting a consumable product contained within the body 100. In some cases, body 100 can be exposed between a proximal end of cap 300 and base 200. In some cases, cap 300 extends to abut the distal end of base 200 such that body 100 is disposed completely within cap 300 and base 200. In such configurations, the cap 300 and base 200 may provide protection for the consumable product and/or may reduce the risk of damage or degradation to body 100.

FIG. 7A and FIG. 7B illustrate a body 100 of biodegradable packaging system 1000, e.g., before and after forming into a final shape for use. A sheet comprising a biodegradable material may be manufactured for forming into body 100 (e.g., as shown in FIGS. 7A, 8A, and 9A). The sheet may comprise an environmentally friendly, biodegradable, compostable, or sustainable material. For example, the sheet may comprise paper, cardboard, plant-based materials, compostable materials, cornstarch-based materials, mycelium, or other biodegradable or sustainable material. The cap 300 and the base 200 may also comprise an environmentally friendly, biodegradable, compostable, or sustainable material. The cap 300 or the base 200 may comprise paper, cardboard, plant-based materials, compostable materials, cornstarch-based materials, mycelium, or other biodegradable or sustainable material.

In some cases, one or more biodegradable materials can be manufactured into a flat sheet 170. In some cases, the sheet 170 is manufactured with one or more tear lines 103 (e.g., wherein one or more of the one or more tear lines 103 comprises a perforation and/or a scoring line), for example, as a continuous sheet 170 or as individual sheets 170. In some cases, a continuous sheet 170 of the biodegradable material can be cut to a desired horizontal length 964 for forming into a final shape of body 100. In some cases, a sheet 170 comprising one or more biodegradable materials is manufactured and then one or more tear lines 103 are introduced in to the shape with desired width(s) and/or in a desired number per vertical distance of the sheet (e.g., to form detachable strips 101). The body 100 may then be formed into a final shape (e.g., a three-dimensional shape), such as the cylinder shown in FIG. 7B. In some cases, forming body 100 into a final shape comprises applying an adhesive 166 to at least a portion (e.g., at a first and/or second end) of sheet 170 and/or one or more detachable strips 101 of sheet 170 (e.g., as shown in FIG. 7C). Forming body 100 into a final shape can comprise joining (e.g., coupling) a first portion (e.g., a first surface at a first end of sheet 170) to a second portion (e.g., a second surface at a second end of sheet 170, for example, wherein the second surface is opposite the first surface) of sheet 170, e.g., using an adhesive. In some cases, all or a portion of the material comprising body 100 (e.g., a sheet comprising one or more detachable strips 101) is wrapped around a consumable product 400. In some cases, all or a portion of the material comprising body 100 (e.g., a sheet comprising one or more detachable strips 101) is pressed into the consumable product 400 to form body 100 in a final shape. In some embodiments, the sheet may be wrapped around the consumable product 400 such that a first end of the strips overlaps a second end of the strips (FIG. 7B). The body may be configured such that the tabs 102 are accessible on an outer surface of body 100 (e.g., after a cap 300 has been removed, if present in the biodegradable packaging system 1000). In some cases, sheet 170 is formed into a three-dimensional shape and then a consumable product 400 is filled inside of body 100 (e.g., via an aperture at a distal end 112 of body 100 or via an aperture at a proximal end 110 of body 100 and/or an aperture in a proximal surface of base 200 or plug 500). A sheet 170 comprising a plurality of detachable strips 101 can have a horizontal length 964 (e.g., from a tip of a first end of a detachable strip of sheet 170 to a tip of a second end of a detachable strip of sheet 170) of 10 mm to 1,000 mm, 25 mm to 500 mm, 50 mm to 250 mm, 100 mm to 150 mm, or more than 1,000 mm.

In some cases, body 100 is formed into a final shape so that a fiber and/or grain direction 180 of the material of body 100 is optimized for tearing along at least a portion of one or more tear lines 103. In some cases, a fiber and/or grain direction 180 of a material of body 100 is optimized for tearing along at least a portion of one or more tear lines 103 by forming sheet 170 so that the direction 180 of the fiber and/or grain is parallel with the portion of the one or more tear lines 103. For example, manufacturing a sheet 170 so that the fiber and/or grain direction 180 is horizontal can help to optimize tearing along a horizontally oriented tear line 103, for example, as shown in FIG. 7C.

A plurality of tear lines 103 of body 100 can be parallel, as shown in FIG. 4, FIG. 5, and FIG. 7A-FIG. 9B. In some embodiments, the one or more tear lines 103 are straight (e.g., in a circumferential or generally circumferential direction), as shown in FIG. 4, FIG. 5, and FIGS. 7A and 7B. In some cases, one or more tear lines 103 are not straight (e.g., in a circumferential or generally circumferential direction), e.g., as shown in FIG. 8A-FIG. 9B. In some cases, one or more detachable strips 101 (e.g., wherein the one or more detachable strips 101 have a constant width or wherein the one or more detachable strips 101 have a non-constant width) are oriented in a single (e.g., horizontal, circumferential, or substantially horizontal) direction relative to a longitudinal axis 700 of body 100. In some cases, one or more detachable strips 101 are not oriented in a single direction around the perimeter (e.g., circumference) of body 100. In some cases, a body 100 comprising detachable strips oriented in a single, horizontal direction (e.g.,, as shown in FIG. 8A and FIG. 8B) may be especially useful in biodegradable packaging systems comprising a beauty product such as blush, concealer, foundation, eyeshadow, or eyeliner. For example, such a configuration may facilitate even application of the beauty product to a skin area. In some cases, a body 100 comprising detachable strips 101 oriented in a curved or wavy pattern (e.g., as shown in FIG. 8A and FIG. 8B) may be especially useful in in containing a personal hygiene product such as deodorant. For example, such a configuration may allow better contouring to the shape of the skin to which the exposed product is applied (e.g., the underarm), e.g., to increase comfort during application. In some cases, a body 100 comprising detachable strips 101 oriented in a peaked (e.g., chevron-shaped) patter (e.g., as shown in FIG. 9A and FIG. 9B), may be especially useful in containing a beauty product such as lipstick. For example, such a configuration may facilitate precision application of the beauty product.

In many cases, body 100, base 200, cap 300, consumable product 400, plug 500, and/or end plate 600 or 620 can have a circular shape in transverse cross-section (e.g., in a plane perpendicular to longitudinal axis 700). It is contemplated that body 100, base 200, cap 300, consumable product 400, plug 500, and/or end plate 600 or 620 may comprise a different and/or additional shape in transverse cross-section. In some cases, the shape of body 100, base 200, cap 300, consumable product 400, plug 500, and/or end plate 600 or 620 can comprise a different shape (e.g., in transverse cross-section) at a first point along longitudinal axis 700 compared to a second point along longitudinal axis 700. In some cases, the change in shape from a first longitudinal position to a second longitudinal position can be continuous (e.g., along all or a portion of body 100, base 200, cap 300, consumable product 400, plug 500, and/or end plate 600 or 620). In some cases, the change in shape along longitudinal axis 700 can be discrete (e.g., a discrete change from a first inner and/or outer diameter to a second inner and/or outer diameter). In some embodiments, the body may have an oval or elliptical cross-sectional area.

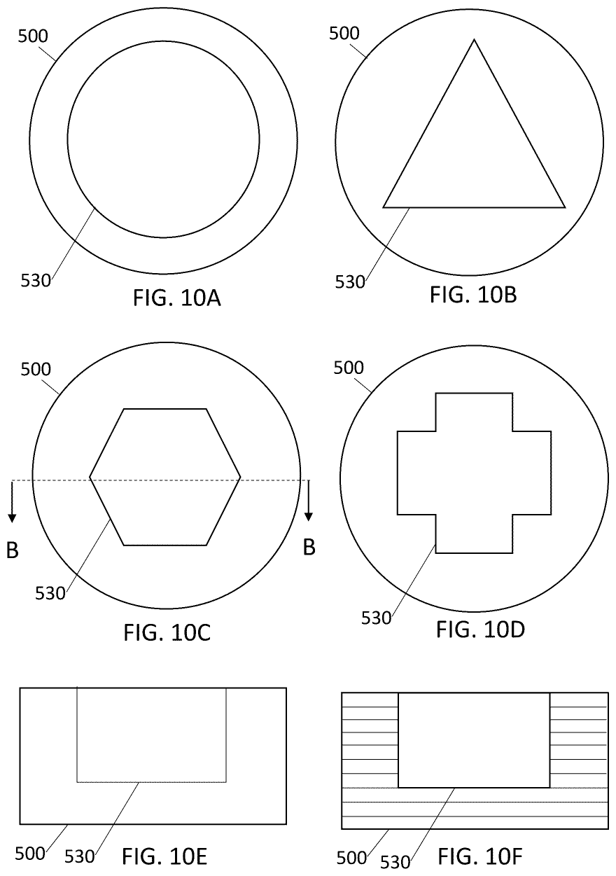

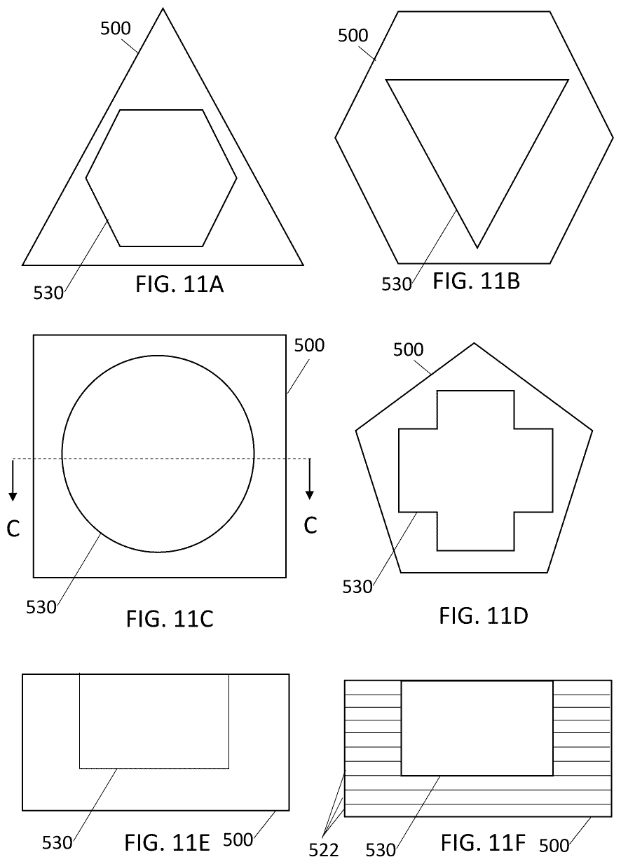

In some cases, the shape (e.g., transverse cross-sectional shape) of an inner surface or portion thereof of a body 100, base 200, cap 300, and/or plug 500 can be the same as the shape of an outer surface or portion thereof of the component (e.g., body 100, base 200, cap 300, and/or plug 500), for example, as shown in FIG. 10A. In some cases, the shape (e.g., transverse cross-sectional shape) of an inner surface or portion thereof of a body 100, base 200, cap 300, and/or plug 500 can be different than the shape of an outer surface or portion thereof of the component (e.g., body 100, base 200, cap 300, plug 500, and/or end plate 600 or 620), for example, as shown in FIG. 10B-FIG. 10D and FIG. 11A-FIG. 11D. It is noted that, while FIGS. 10A-10D and FIGS. 11A-11D are labeled as plugs 500 with plug cavities 530, a body 100, base 200, and/or cap 300 can comprise a transverse cross-sectional shape (e.g., of the outer, inner, or outer and inner surfaces) depicted in FIGS. 10A-10D or FIGS. 11A-11D. In some embodiments, a body 100, base 200, cap 300, consumable product 400, plug 500, and/or end plate 600 or 620 may comprise a transverse cross-sectional shape (e.g., of an inner surface and/or an outer surface) of a circle, an ellipse, an oval, a square, a rectangle, a triangle, a pentagon, a hexagon, a heptagon, an octagon (or other polygon), or non-standard shapes (e.g., a heart or hourglass shape). Cap 300, base 200, or both may have a cross-sectional shape corresponding to a cross-sectional shape of body 100 or consumable product 400. In some embodiments, the cap or the base may have circular horizontal cross-sectional area. In some embodiments, the cap or the base may have an oval or elliptical cross-sectional area.

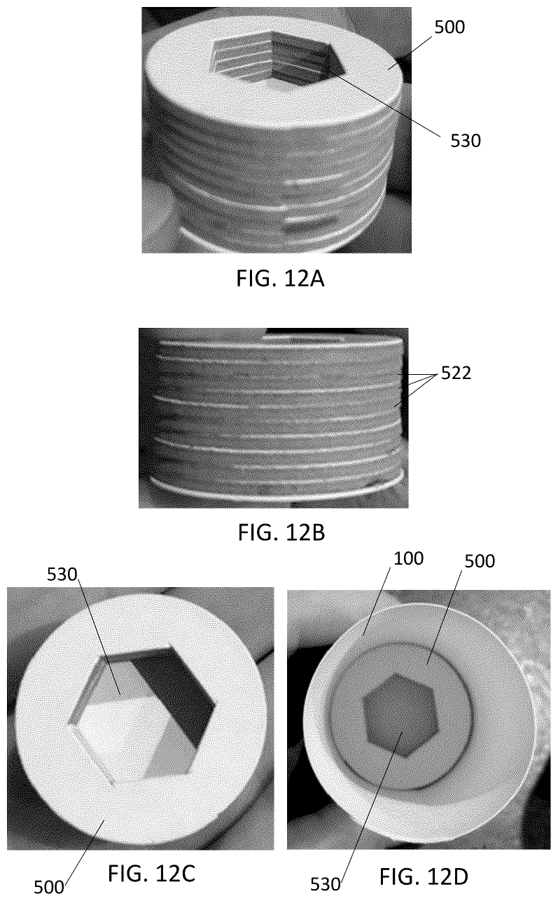

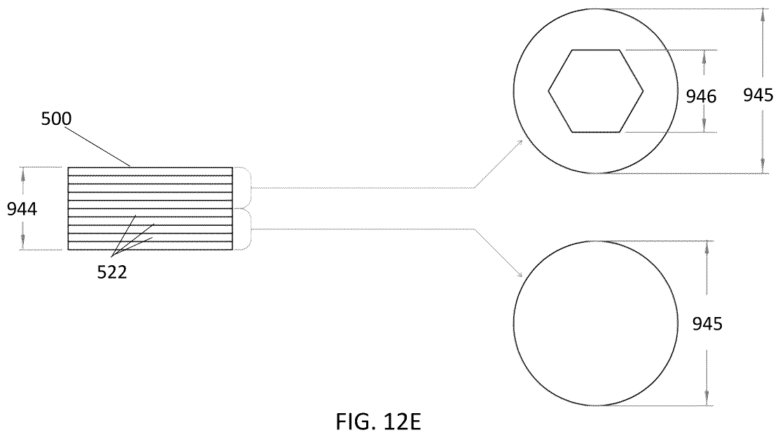

FIGS. 10E, 10F, 11E, and 11F show cross-sectional views (e.g., along the coronal plane indicated by dotted lines B-B and C-C) of exemplary plugs 500 shown in FIGS. 10C and 11C. Plug 500 can be a single continuous material (e.g., as shown in FIG. 10E and FIG. 11E) or a layered component (e.g., as shown in FIG. 11E and FIG. 11F). In some cases, a layered component (e.g., a plug 500 comprising a plurality of layers 522) can be more stiff than a component comprising a single-continuous material (e.g., wherein the single-continuous material has a thickness equal to the thickness of one or more layers 522 of the layered component). In some cases, a layered plug 500 can be easier to manufacture than a plug comprising a single continuous material. FIGS. 12A-12C show views of layered plugs 500, and FIGS. 2B, 2C and 12D show a plug 500 disposed within a body 100. In some cases, at least a portion of plug 500 is disposed within base 200. FIG. 12E shows a side view of a plug 500 comprising layers 522 of circular discs with hexagonal apertures and layers 522 of circular discs having no aperture. In some cases, plug 500 comprises 1, 2, 3, 4, 5, 6, 7, 8, 9, 10, 11, 12, 13, 14, 15, 16, 17, 18, 19, 20, or more than 20 layers 522. A layer 522 of plug 500 can have a thickness of from 0.1 mm to 20 mm, from 0.5 to 15 mm, from 1 mm to 10 mm, from 2 mm to 5 mm, or greater than 20 mm. In some cases, a layer 522 of plug 500 can have a thickness of about 0.5 mm, about 1 mm, about 2 mm, about 3 mm, about 4 mm, or about 5 mm. In some cases, a first layer 522 of plug 500 has a thickness equal to a second layer 522 of plug 500. In some cases, a first layer 522 of plug 500 has a thickness different than a second layer 522 of plug 500. In some cases, each layer 522 of plug 500 has the same thickness as each other layer of plug 500, for example, to simplify the manufacturing process. Plug 500 can comprise one or more layers 522 comprising an aperture and one or more layers 522 comprising no apertures, for example, as shown in FIG. 12E. In some cases, plug 500 comprises 1, 2, 3, 4, 5, 6, 7, 8, 9, 10, 11, 12, 13, 14, 15, 16, 17, 18, 19, 20, or more than 20 layers 522 comprising one or more apertures. In some cases, the number of layers 522 comprising one or more apertures is equal to the number of layers 522 comprising no apertures. In some cases, the number of layers 522 comprising one or more apertures is greater than the number of layers 522 comprising no apertures. In some cases, the number of layers comprising one or more apertures is less than the number of layers 522 comprising no apertures. In some cases, an aperture of a plug layer 522 has a maximum dimension from 5 mm to 40 mm, from 10 mm to 30 mm, from 20 mm to 25 mm, or less than 5 mm. In some cases, an aperture of a plug layer 522 can have a circular shape. In some cases, an aperture of a plug layer 522 can have a polygonal shape. In some cases, a side of an aperture having a polygonal shape can have a length 946 of from 5 mm to 30 mm, from 10 mm to 20 mm, from 10 mm to 15 mm, or less than 5 mm. The shape of a layer 522 of a plug 500 or an aperture of a layer 522 of a plug 500 can be diecut or laser cut in a material (e.g., paperboard or millboard). In many cases, a material used to form a layer 522 of a plug 500 is uncoated prior to assembly of the layers 522 of the plug. The aperture(s) of one or more layers 522 of plug 500 can form a cavity 530, which can be useful in resisting movement (e.g., rotational or bending movement) of the consumable product 400 during use, for instance, wherein the consumable product is disposed at least partially within cavity 530 of plug 500 and/or base 200 (e.g., wherein at least a portion of plug 500 is disposed within base 200).

### Materials

In many cases, a biodegradable packaging system or portion thereof comprises a biodegradable packaging material. For instance, a body 100 or portion thereof (e.g., one or more detachable strips 101) can comprise a biodegradable packaging material. In many cases, a base 200 of a biodegradable packaging system 1000 comprises a biodegradable packaging material. In many cases, a cap 300 of a biodegradable packaging system 1000 comprises a biodegradable packaging material. In many cases, a plug 500 or portion thereof can comprise a biodegradable packaging material. In some cases, an end plate (e.g., a proximal end plate 600 and/or a distal end plate 620) can comprise a biodegradable packaging material.

Biodegradable packaging materials useful in the packaging systems 1000 or a portion thereof (e.g., a body 100, a base 200, a cap 300, a plug 500, a proximal end plate 600, a distal end plate 620, or a portion of any of those components) presented herein can include paper, cardboard, plant-based materials, compostable materials, cornstarch-based materials, mycelium, or other biodegradable or sustainable material. In many cases, a biodegradable packaging system 1000 or a portion thereof (e.g., a body 100, a base 200, a cap 300, a plug 500, a proximal end plate 600, a distal end plate 620, or a portion of any of those components) comprises paper or a paper product. In some cases, a biodegradable packaging system 1000 or portion thereof consists essentially of paper or a paper product. A biodegradable packaging material can comprise a post-market paper product, such as a recycled paper. In some cases, a post-market paper product is treated, for example, with a dye, bleach, or detergent. In some cases, a biodegradable packaging material comprises tube board, paperboard, millboard, greyboard, art paper, card stock, cardboard, fiberboard, wood pulp, solid bleached board (e.g., solid bleached sulphate, SBS). In some cases, a biodegradable packaging material is certified for environmental sustainability by a third party, such as the Forest Stewardship Council (FSC). For example, a biodegradable packaging material can be a certified sustainable recycled paper, a certified sustainable paperboard, or a certified sustainable millboard. A biodegradable packaging material may comprise a post-industrial resin (PIR). In some cases, a biodegradable packaging material may comprise a post-consumer resin (PCR). In some cases, a biodegradable packaging material (e.g., a paper product) can comprise cotton, linen, hemp, abaca, or kozo.

In some cases, a packaging material of a biodegradable packaging system 1000 can comprise a coating. For example, SBS can comprise a bleached chemical pulp core coated on each side with one or more coatings. In some cases, a coating of a packaging material of a biodegradable packaging system 1000 can comprise a polymer. In some cases, a coating of a packaging material of a biodegradable packaging system 1000 can comprise a varnish, talc, bentonite, calcium carbonate, kaolinite, a latex, a starch, a dispersant, polyethylene, polyolefin, silicone, or wax. A coating can be compostable. For example, a coating can comprise a compostable was, such as a soybean-based wax. In some cases, a body 100, a base 200, and/or a cap 300 can comprise a coating (such as a compostable wax coating) on one or more surface. In some cases, it is advantageous to coat all or a portion of one surface of a component (e.g., a body 100, a base 200, and/or a cap 300) of a biodegradable packaging system and not to coat all or a portion of a second surface of the component. For example, it can be beneficial to coat an inner surface 340 of cap 300 or an inner surface of body 100 with a compostable wax in order to decrease friction between the cap 300, the body 100, and/or the product 400. It can beneficial not to coat an outer surface of a body 100 or cap 300 that has a coated inner surface 340, for example, because it can improve the biodegradation characteristics of the body 100 or cap 300 and because it can decrease cost and/or complexity of manufacturing processes.

In some cases, a coating can function as an adhesive. In many cases, an adhesive used in a biodegradable packaging system 1000 presented herein comprises a compostable adhesive, such as a bio-based glue. For example, a biodegradable packaging material (e.g., a starch) can be used to adhere a first layer of a laminated packaging material to a second layer of the laminated packaging material or a first component of a biodegradable packaging system (e.g., a body 100 or plug 500) to a second component of a biodegradable packaging system (e.g., a base 200). A cap 300 can comprise a coating, for example, on an inner surface 340 of the cap 300 as shown in FIG. 13B. In some cases, a portion of a biodegradable packaging system 1000 (e.g., body 100, base 200, cap 300, or a portion of one or more thereof) can be comprise a pigment (e.g., a compostable pigment, such as a soy-based ink).

In some cases, a biodegradable packaging material and/or coating thereof can impart improved water resistance, wet strength, scent containment, and/or scent protection to the biodegradable packaging material and/or biodegradable packaging system 1000, which can be beneficial for packaging consumable products having appreciable water content, for example, as in systems used to package some cosmetics and hygiene products. For example, SBS, which has low odor, can be useful in biodegradable packaging systems as it does not affect the perceived scent of consumer products contained therein, which may comprise a desired scent. In some cases, a biodegradable packaging material and/or coating thereof can impart a desired texture and/or appearance to the packaging. For example, a biodegradable packaging material or coating thereof can be selected to result in a matte or glossy finish to the product. In some cases, a biodegradable packaging material or coating thereof can be selected for chemical non-reactivity with a material of a product contained in the packaging. In some cases, a packaging material or coating thereof can be selected to improve the adhesion of a portion of the packaging system to a consumable product contained therein. For example, selecting a biodegradable packaging material or coating thereof that increases adhesion or friction with a consumable product 400 disposed therein can maintain the position of the consumable product 400 within the packaging system (e.g., thereby reducing the risk that the product will slide out of the packaging when opened or used). In some cases, selecting a biodegradable packaging material or coating thereof can reduce adhesion or friction with a consumable product 400 within the packaging system (e.g., thereby reducing the risk of a product or portion thereof being pulled away with a detachable strip 101 when the detachable strip 101 is removed during use).

In some cases, a surface of a biodegradable packaging material comprises texturing, for example, to improve a user's grip on the packaging system, to improve friction between the packaging material and a consumable product 400 in contact with the packaging material, and/or to achieve a desired appearance or tactile experience.

In some cases, a biodegradable packaging material can be a layered or laminated material. In some cases, the number of layers 522 of a layered or laminated material for use in a biodegradable packaging system 1000 (or portion thereof) can be selected to achieve a desired thickness, which may confer a desired stiffness or strength to the packaging system or portion thereof. For example, a layered or laminated material can comprise 2, 3, 4, 5, 6, 7, 8, 9, 10, or more than 10 layers to improve the stiffness or strength of a packaging material or packaging system component. A layered or laminated material can comprise 2, 3, 5, 6, 7, 8, 9, 10, or more than 10 layers to achieve a desired height or thickness of a packaging system component. For example, a layered material used to form all or a portion of a plug 300 can comprise 2, 3, 5, 6, 6, 7, 8, 9, 10 or more than 10 layers to achieve a desired thickness of the plug 300 in the packaging system, e.g., to improve positioning of the product 400 within the packaging system (e.g., along a longitudinal axis 700 of the system) and/or to increase the surface area of a contact surface of the plug 300 (e.g., an inner contact surface of a cavity 530 of a plug 300, which may be in contact with product 400, and/or an outer contact surface of a plug 300, which may be in contact with a body 100 or base 200), for example to improve grip, adhesion or resistance to circumferential rotation or axial displacement). In some cases, the number of layers of a layered or laminated material for use in a biodegradable packaging system 1000 or portion thereof can be selected to achieve a desired level of water resistance. For example, a layered or laminated material can comprise 2, 3, 4, 5, 6, 7, 8, 9, 10, or more than 10 layers to improve water resistance.

A body 100 (or portion thereof) of a biodegradable packaging system 1000 can be a layered or laminated material, e.g., comprising a plurality (e.g., 2, 3, 4, 5, 6, 7, 8, 9, 10 or more than 10) of layers 522. A base 200 (or portion thereof) of a biodegradable packaging system 1000 can be a layered or laminated material, e.g., comprising a plurality (e.g., 2, 3, 4, 5, 6, 7, 8, 9, 10 or more than 10) of layers 522. A cap 300 (or portion thereof) of a biodegradable packaging system 1000 can be a layered or laminated material, e.g., comprising a plurality (e.g., 2, 3, 4, 5, 6, 7, 8, 9, 10 or more than 10) of layers 522. A plug 500 (or portion thereof) of a biodegradable packaging system 1000 can be a layered or laminated material, e.g., comprising a plurality (e.g., 2, 3, 4, 5, 6, 7, 8, 9, 10 or more than 10) of layers 522. An end plate 600 or 620 (or portion thereof) of a biodegradable packaging system 1000 can be a layered or laminated material, e.g., comprising a plurality (e.g., 2, 3, 4, 5, 6, 7, 8, 9, 10 or more than 10) of layers 522.

### EXAMPLES

### Example 1

This example shows a biodegradable packaging system comprising a body 100 having a plurality of detachable strips 100.

A sheet of 190 gram per square meter (gsm) solid bleached sulphate (SBS) is manufactured with an outer laminate of 0.15 mm matte laminate. Seven detachable strips 101, each having a width of 8 mm are defined in the sheet by scoring the sheet to create tear lines 103 starting 8 mm away from a distal end of the sheet before the sheet is cut to an overall height of 60 mm. A die press used to die cut sheet to a horizontal length of 140 mm, with a contoured blade of the die press used to cut the shapes of the tabs to coincide with the positions of the tear lines 103 (e.g., as shown in FIG. 2A and FIG. 3C) at a first end and with the straight-edged blade to cut the sheet at a second end. A line of bio-based compostable adhesive is painted in a line at the second end of the manufactured sheets 170 on a first surface of the sheets. The second end is then curled into a cylinder such that adhesive coating a portion of the second end of the first surface of a sheet contacts a second surface of the first end of the sheet 10 mm from the contoured edge of the first end of the sheet to join the second end to the first end of the sheet and form the three-dimensional cylindrical shape of the body 100. Alternatively, the sheet can be press-fit to a cylinder of stick deodorant to form body 100.

### Example 2

This example shows a biodegradable packaging system comprising a base 200 and a body 100 having a plurality of detachable strips 100.

A body 100 comprising a plurality of detachable strips 100 is provided as in Example 1. A second sheet comprising 250 gsm FSC-certified paperboard coated with soybean-based compostable wax is fabricated and formed into a base 200 having a longitudinal height of 30 mm and a thickness of 3 mm, for example, as shown in FIG. 2A and FIG. 3B. A 10 mm band the outer surface of body 100 at the proximal end of body 100 is coated lightly with starch-based adhesive and inserted into base 200 until the proximal end of body 100 contacts the inner surface of the proximal end of base 200. The joined base and body are allowed to set overnight.

### Example 3

This example shows a biodegradable packaging system comprising a cap 300, a base 200, and a body 100 having a plurality of detachable strips 100.

A base 200 is fabricated and coupled to a body 100 as shown in Example 2. An additional sheet comprising 250 gsm FSC-certified paperboard coated with soybean-based compostable wax is fabricated and formed into a cap 300 having a longitudinal height of 60 mm and a thickness of 3 mm, for example, as shown in FIG. 2A and FIG. 3A. The cap is advanced over body 100 until the proximal end of cap 300 abuts the distal end of base 200.

### Example 4

This example shows a biodegradable packaging system comprising a plug 500, a cap 300, a base 200, and a body 100 having a plurality of detachable strips 100.

A base 200 is fabricated and coupled to a body 100 as shown in Example 2. A sheet of 2 mm greyboard laminated with 350 gsm SBS is fabricated before eight hexagonal apertures having sides of 15 mm each are punched in the sheet. Eight circles having a diameter of 47 mm concentric to the centers of the eight hexagonal apertures are punched, and two additional circles with a diameter of 47 mm are punched in the sheet to create ten discs. Lower surfaces of the eight discs comprising hexagonal apertures and the two discs without hexagonal apertures are coated lightly with starch-based adhesive. The coated discs are assembled in a stack (e.g., as shown in FIGS. 12A-12C, with the coated surfaces facing the next disc below it, and the two discs without apertures on the bottom of the stack to form plug 500. Plug 500 is then inserted into body 100 until the lower surface of the bottommost disc is in contact with the inner surface of the proximal end of the base 200 (e.g., as shown in FIG. 2C and FIG. 12D) and allowed to set overnight. Cap 300, fabricated as shown in Example 3, is slid over body 100 to form biodegradable packaging system 1000.

### Example 5

This example shows a biodegradable packaging system comprising a plug 500, a cap 300, a base 200, and a body 100 having a plurality of detachable strips 100 for use in commercial retail of stick deodorant.

A base 200 is fabricated and coupled to a body 100 as shown in Example 2. A sheet of 2 mm greyboard laminated with 350 gsm SBS is fabricated before eight hexagonal apertures having sides of 15 mm each are punched in the sheet. Eight circles having a diameter of 47 mm concentric to the centers of the eight hexagonal apertures are punched, and two additional circles with a diameter of 47 mm are punched in the sheet to create ten discs. Lower surfaces of the eight discs comprising hexagonal apertures and the two discs without hexagonal apertures are coated lightly with starch-based adhesive. The coated discs are assembled in a stack (e.g., as shown in FIGS. 12A-12C, with the coated surfaces facing the next disc below it, and the two discs without apertures on the bottom of the stack to form plug 500.

Stick deodorant ingredients are combined in a jacketed stainless steel kettle and heated while mixing. The stick deodorant mixture comprises aluminum zirconium tetrachlorohydrex glycine, a gelling agent, and, optionally, a fragrance and/or a colorant. It is contemplated that aluminum chlorohydrate, aluminum chloride, aluminum sulfate, and/or another aluminum zirconium compound can be used in place of or in addition to the aluminum zirconium tetrachlorohydrex glycine. Stearyl alcohol, cetyl alcohol, hydrogenated castor oil, and/or glyceryl stearate can be used as a gelling agent. The stick deodorant mixture is poured into a mold, and plug 500 is pressed into the mixture, with the hexagonal apertures facing toward the mixture, and the mixture is cooled. After cooling, deodorant sticks with attached plugs 500 are released from the mold and is then inserted into body 100 until the lower surface of the bottommost disc is in contact with the inner surface of the proximal end of the base 200 (e.g., as shown in FIG. 2C and FIG. 12D) and allowed to set overnight.

Alternatively, a consumable product, such as a melted stick deodorant, can be loaded incorporated into a biodegradable packaging system using a bottom-fill method. For instance, body 100 and base 200 can be prepared as described above and plug 500 can be inserted into body 100. Optionally, plug 500 can be coupled to base 200 (e.g., via adhesive on an outer surface of plug 500 and/or an inner surface of the base 200, which can comprise an aperture).

The liquid or melted consumable product (for instance, stick deodorant mixture) is poured into the open distal end of body 100 and cooled.

It is contemplated that this process is amenable to production of biodegradable packaging systems for commercial retail of other consumable products, such as lipstick or other cosmetics and personal hygiene products. In some cases, manufacture of biodegradable packaging systems for commercial retail of other consumable products may comprise additional steps (e.g., finishing steps, such as heating the surface of the product, for example in the production of lipstick packaging systems).

Cap 300, fabricated as shown in Example 3, is slid over body 100 to form biodegradable packaging system 1000.

### Example 6

This example shows a biodegradable packaging system comprising a plug 500, a cap 300, a base 200, and a body 100 having a plurality of detachable strips 100 for use in commercial retail of stick deodorant.

A base 200 comprising an aperture centered on a proximal end surface of base 200 is fabricated and coupled to a body 100 formed as shown in Example 1. A sheet of 2 mm greyboard laminated with 350 gsm SBS is fabricated before ten hexagonal apertures having sides of 15 mm each are punched in the sheet. Ten circles having a diameter of 47 mm concentric to the centers of the ten hexagonal apertures are punched to create ten discs. Lower surfaces of nine of the ten discs comprising hexagonal apertures are coated lightly with starch-based adhesive. The coated discs are assembled in a stack (e.g., as shown in FIGS. 12A-12C, with the coated surfaces facing the next disc below it to form plug 500. Adhesive is painted around the perimeter of the plug, and the plug is inserted into body 100 so that the hexagonal apertures of the discs of plug 500 are aligned with the aperture of base 200. Cap 300, fabricated as shown in Example 3, is slid over body 100 to form biodegradable packaging system 1000.

A stick deodorant mixture is formed as in Example 5 and poured through the aperture in the proximal end of the biodegradable packaging system at least until the mixture reaches plug 500. The assembly is then cooled to set the deodorant mixture inside of the biodegradable packaging system. It is contemplated that this process is amenable to production of biodegradable packaging systems for commercial retail of other consumable products, such as lipstick or other cosmetics and personal hygiene products. In some cases, manufacture of biodegradable packaging systems for commercial retail of other consumable products may comprise additional steps (e.g., finishing steps, such as heating the surface of the product, for example in the production of lipstick packaging systems).

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

1-28. (canceled)

29. A packaging system comprising:
a single body comprising a plurality of detachable strips that do not substantially overlap, wherein a detachable strip of the plurality of detachable strips is separated from an adjacent detachable strip of the plurality of detachable strips by a tear line and wherein the body comprises a first biodegradable material, wherein the first biodegradable material comprises tube board, paper board or solid bleached sulfate (SBS); and
a base coupled to a proximal end of the body.

30. The packaging system of claim 29, wherein the proximal end of the body is disposed at least partially within a cavity of the base.

31. The packaging system of claim 29, wherein the base comprises a second biodegradable material.

32. The packaging system of claim 29, further comprising a cap.

33. The packaging system of claim 32, wherein the cap comprises a second biodegradable material.

34. The packaging system of claim 32, wherein a proximal end of the cap abuts a distal end of the base.

35. The packaging system of claim 29, wherein the first end of the body comprises a knurled edge.

36. The packaging system of claim 29, further comprising a plug.

37. The packaging system of claim 36, wherein at least a portion of the plug is disposed within a cavity of the base.

38. The packaging system of claim 29, further comprising a consumable product disposed substantially inside of the body.

39. The packaging system of claim 38, wherein the consumable product is disposed at least partially within the cavity of the base.

40. The packaging system of claim 38, further comprising a plug, wherein the consumable product is in contact with a distal end of the plug.

41. The packaging system of claim 38, further comprising a plug, wherein the plug comprises one or more prongs, wherein at least one of the one or more prongs extends inside of the consumable product.

42. The packaging system of claim 29, wherein a detachable strip of the plurality of detachable strips comprises a tab at a first circumferential end of the detachable strip.

43. The packaging system of claim 42, wherein the tab overlaps a second circumferential end of the detachable strip.

44. The packaging system of claim 29, wherein each detachable strip of the plurality of detachable strips is separated from an adjacent detachable strip of the plurality of detachable strips by a tear line.

45. The packaging system of claim 29, wherein the first biodegradable material comprises paper.

46. The packaging system of claim 29, wherein the biodegradable material comprises solid bleached sulfate (SBS).

47. The packaging system of claim 29, wherein a height of the body is from 25 mm to 200 mm.

48. The packaging system of claim 29, wherein an outer diameter of the body is from 25 mm to 75 mm.
